(19) United States
(12) Patent Application Publication
(10) Pub. No.: US 2004/0249889 A1
(43) Pub. Date: Dec. 9, 2004

(54) Method and system for processing interactive communications

(76) Inventor: David E. Drommond, Bountiful, UT (US)

Correspondence Address: Vaughn W. North, THORPE NORTH & WESTERN, LLP, P.O. Box 1219, Sandy, UT, 84091-1219, US

(21) Appl. No.: 10/859,731

(22) Filed: Jun. 2, 2004

Related U.S. Application Data
(60) Provisional application No. 60/475,678, filed on Jun. 3, 2003.

(51) Int. Cl. G06F 15/16; H04L 12/16; H04Q 11/00

(52) U.S. Cl. 709/204; 370/260

(57) ABSTRACT

A method for processing interactive communications in a meeting space shared by attending participants who are visually present with each other. The method includes the steps of providing electronic display devices to a plurality of participants, including individual video monitors on each display device, linking the electronic display devices for interactive processing of conference data among participants and a speaker, and monitoring and modifying a flow of conference data between the electronic display devices. The method may also include the step of activating a participant's image on another participant's display device, thus enabling interactive communication between at least two participants. Furthermore, the step of monitoring and modifying a flow of conference data may include assigning an electronic display device with presenter status, assigning communication priority to a specific electronic display device, or personalizing the display characteristics of the electronic display device to conform to preferences of an individual participant.

This application claims priority to the provisional application No. 60/475,678 filed Jun. 3, 2003 in the United States Patent and Trademark Office.

### BACKGROUND OF THE INVENTION

1. Field of the Invention

The present invention relates generally to communication to and within a group in attendance at a conference, classroom or meeting. More particularly, the present invention relates to creating a more intimate and productive communication experience to and within the group.

2. Related Art

Communication among individuals plays a very important role in many aspects of human life, from the development of the basic personality to the regulation of international affairs. One important aspect of communication is the attentiveness of one party while another party is speaking. There is clearly a direct correlation between the attentiveness of an individual to a communication event and the understanding and retention of the communicated information by that individual.

Visual perception plays a very important role in human communication. It has been shown that visual cues enhance human understanding of a communicated subject. It has also been demonstrated that visual cues may even alter the perceived content of an auditory message. When individuals are physically together and communicating face-to-face, with direct eye contact, attentiveness and perception may be enhanced dramatically. The dynamics of communication to and within a group sitting in a class, conference room or other meeting space, however, do not conform to this optimal situation. Attention is usually focused on a single speaker, often lacking in interactive contact with other group members.

Communicated messages to such groups of individuals play a very important role in our society, examples of which occur in class rooms, board meetings, conference centers, and court rooms. Given the often critical nature of the activities that take place in these environments, it is curious that so little attention is paid to the effectiveness of such communications. Take for example a board meeting in a typical conference room. In these environments there is usually a long table from which a presenter may speak from one end. In addition to lacking direct face-to-face contact, the individuals in the room typically have at least one other person between them and the presenter, thus creating potential distractions that may limit the effectiveness of the communication. Clearly, this falls short of direct fact-to-face contact. A similar situation exists in the classroom, where every student behind the front row must deal with all the distractions between them and the teacher. This situation is compounded in large rooms where it may be difficult for all individuals in the room to hear or see the presenter.

Attempts to improve communication efficiency in meeting environments have largely been unsuccessful. Audio is often amplified in an attempt to overcome acoustic issues inherent in large meeting rooms. This solution may, however, make the meeting uncomfortable for those individuals seated near speakers. In other words, because of the limited number of speaker sources in the room, it is very difficult to personalize the audio experience of an individual in the room. Also, due to the proximity of other meeting rooms, adequate sound levels may be limited to avoid disturbance due to the amplified audio.

An example of an attempt at solving visual distractions employs a projection of the presenter onto a large screen. Although the enlargement of the presenter offers some improvement, it has been demonstrated that it is still difficult for a person to maintain attentiveness to a large magnified head. Optimally, the face of the presenter needs to be life-like in size and configured to maintain eye contact with the participants, a feat that is just not possible in most meeting environments.

### SUMMARY OF THE INVENTION

The invention provides a method for processing interactive communications in a meeting space shared by attending participants who are visually present with each other. The method includes the steps of providing electronic display devices to a plurality of participants, including individual video monitors on each display device, linking the electronic display devices for interactive processing of conference data among participants and a speaker, and monitoring and modifying a flow of conference data between the electronic display devices. The method may also include the step of activating a participant's image on another participant's display device in real time, thus enabling interactive communication between at least two participants in a simulated fact-to-face manner. Furthermore, the step of monitoring and modifying a flow of conference data may include assigning an electronic display device with presenter status, or assigning communication priority to a specific electronic display device. Monitoring and modifying a flow of conference data may also include personalizing the display characteristics of the electronic display device to conform to preferences of an individual participant. Additionally, monitoring and modifying a flow of conference data may also include sending viewable media to the electronic display devices, or tallying voting results from the electronic display devices.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart of a method for processing interactive communications in a meeting space in accordance with an embodiment of the present invention;

FIG. 2 is a flow chart of a method for processing interactive communications in a meeting space in accordance with an embodiment of the present invention;

FIG. 3a is a perspective view of a participant console in accordance with an embodiment of the present invention;

FIG. 3b is a perspective view of a participant console in accordance with an embodiment of the present invention;

FIG. 3c is a perspective view of a participant console in accordance with an embodiment of the present invention;

FIG. 4 is a graphical schematic representing a master equipment station in accordance with an embodiment of the present invention;

FIG. 5 is a graphical schematic representing a slave equipment station in accordance with an embodiment of the present invention; and

FIG. 6 is a graphical schematic representing a system for processing interactive communication in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

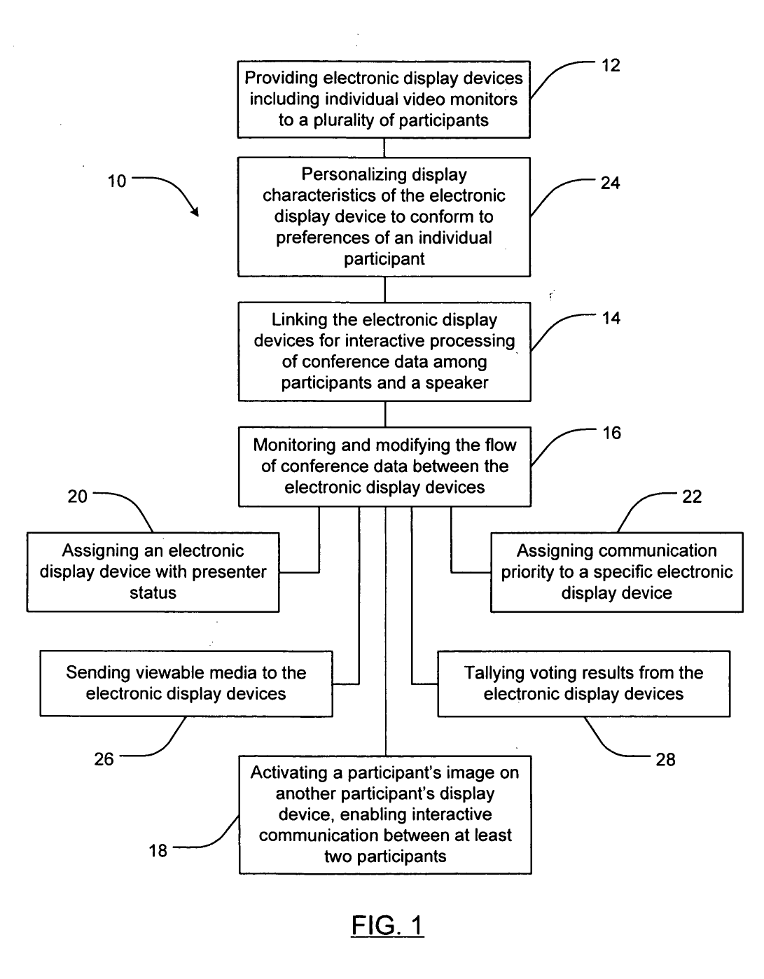

As shown in FIG. 1, the present invention may be embodied as a method 10 for processing interactive communications in a meeting space shared by attending participants who are visually present with each other. It is contemplated that a meeting space is not limited to a business environment, but may include any gathering of people for the purpose of communication, such as, but not limited to, classrooms, meeting rooms, distance learning rooms, videoconferencing rooms, and courtrooms. The method 10 may include providing electronic display devices to a plurality of participants, including individual video monitors on each display device 12. A sufficient number may be provided such that each participant has an electronic display device, or multiple participants can use a single electronic display device. A video monitor is any device that is capable of capturing a video image of a participant for electronic transmission, such as, but not limited to, a video camera.

This method may also include personalizing the display characteristics of the electronic display device to conform to preferences of an individual participant 24. Personalizing characteristics could include altering the volume of the audio signal, adjusting the brightness of the video signal, altering the size of text messages, or any other type of personalization of the conference data known to one skilled in the art.

The method 10 may also include linking the electronic display devices for interactive processing of conference data among at least a portion of the participants and a speaker 14. Conference data may be defined as any data signal that flows from one electronic display device to another. This may include, without limitation, video, audio, text messages, document display, electronic display device status and manually toggled signals from a participant such as voting results. The path of the conference data flow may be over an electric, fiber optic, wireless, or any other communication means known to one skilled in the art. The interactive processing of conference data may include, without limitation, enhancement of the video or audio signal.

The method 10 may also include monitoring and modifying a flow of conference data between the electronic display devices 16. One way in which the flow of conference data may be monitored and modified 16 includes assigning an electronic display device with presenter status 20. The selection of a presenter from a group of participants may be a manual selection based on a decision by a person or it may be an automatic selection in response to a specific event such as, but not limited to, audio or visual motion input from an electronic display device. In the latter case, if events occur simultaneously at multiple electronic display devices, the method 10 contemplates a priority system for selecting and assigning presenter status.

Another way in which the flow of conference data may be monitored and modified 16 includes assigning communication priority to a specific electronic display device 22. The assigning of communication priority 22 may be a manual selection based on a decision by a person or it may be an automatic selection in response to a specific event such as, but not limited to, audio or visual motion input from an electronic display device. In the latter case, if events occur simultaneously at multiple electronic display devices, the method 10 contemplates a priority system for selecting and assigning presenter status.

Additionally, the flow of conference data may be monitored and modified 16 by sending viewable media to the electronic display devices 26. Viewable media may include any type of digital or analogue video signal from sources such as VCRs, DVDs, computers, or any other video sources known to one skilled in the art. It is also contemplated that the monitoring and modification of the flow of conference data 16 may include sending audio media to the electronic display devices. Audio media may include, without limitation, an analogue or digital audio signal from sources such as VCRs, DVDs, computers, MP3 players, tape recorders, or any other audio sources known to one skilled in the art.

Another example of monitoring and modifying a flow of conference data 16 may include tallying voting results from the electronic display devices 28. The method 10 contemplates situations where the participants are required to vote via the electronic display devices. The votes may be tallied manually or automatically and displayed to the presenter or other participants.

The method 10 may also include a step of activating a participant's image on another participant's display device, thus enabling interactive communication between at least two participants 18. The display of a participant's image may be sent to another participant, or to a group of participants. The participant receiving the image is thus involved in a communication experience that is more intimate than a typical conference setting. The attention of a participant may be increased due to the intimate nature of the communication. The head of the presenter is displayed in a more realistic size, thus eliminating the attention problems associated with a large magnified head. This creates the feeling in participants that they are involved in a face to face, direct eye contact communication which will increase their attentiveness, as well as their understanding and retention of the communicated information. Also, the close proximity of the electronic display device to a participant eliminates distractions that occur between the participant and the presenter that occur in a classical conference room or other meeting space setting.

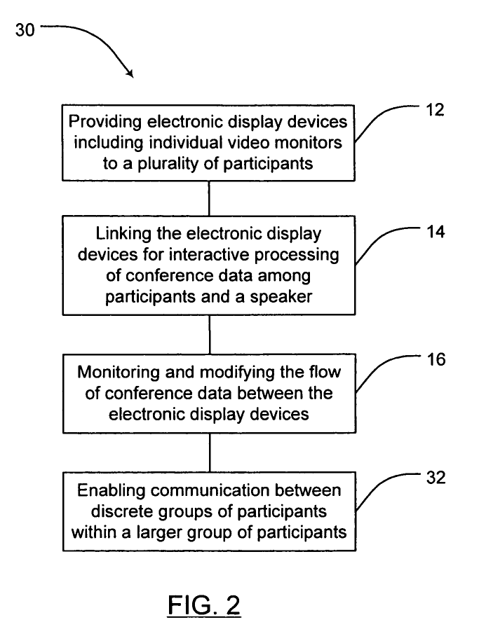

As shown in FIG. 2, the present invention may also be embodied as a method 30 for enabling communication between discrete groups of participants within a larger group of participants 32. This method would include the steps of providing electronic display devices including individual video monitors to a plurality of participants 12, linking the electronic display devices for interactive processing of conference data among participants and a speaker 14, monitoring and modifying the flow of conference data between electronic display devices 16, and enabling communication between discrete groups of participants within a larger group of participants 32. Situations may arise where a larger group of individuals is split up into smaller groups in order to facilitate discussions. In a traditional conference or classroom setting, small group communication requires that all members move to a similar locality in the room. This limits the combinations of members that may comprise a group, unless time is spent to allow a chaotic movement of individuals throughout the room to each group locale. This embodiment of the method 30 contemplates allowing the electronic display devices to display multiple images of other participants, thus forming an intimate group for discussion without the limitations of similar locality between the participants. The method 30 thus also allows dynamic changes of group membership without wasting time while the participants of a given group find and move toward a similar location.

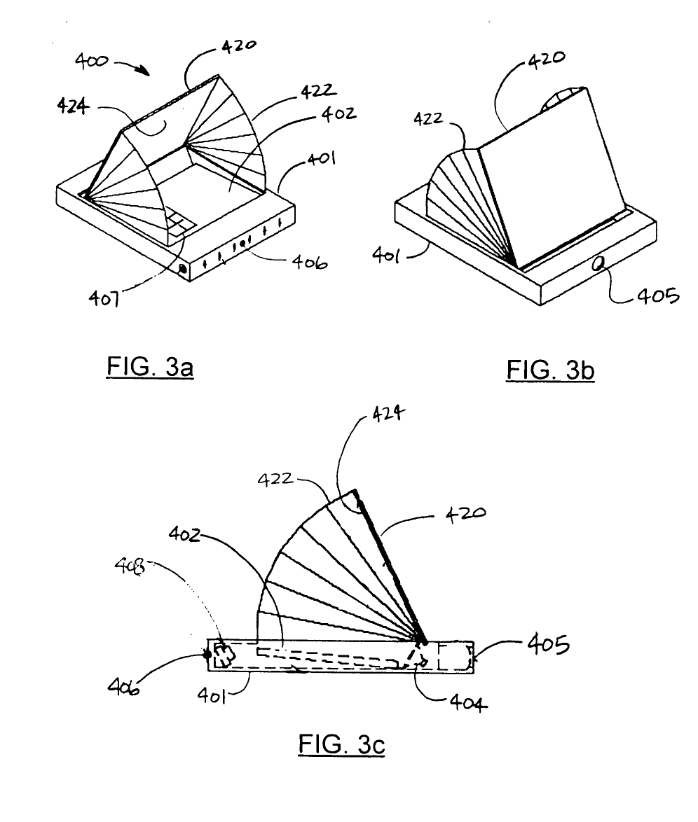

As illustrated in FIGS. 3, 4 and 5, a system in accordance with the present invention is shown for processing interactive communications in a meeting space shared by attending participants who are visually present with each other for purposes of enhancing flow of information. In one example embodiment, each participant console 400 has a housing 401, a video screen 402, one or more speakers 404, a microphone 406, and a camera 408. The camera 408 may be aligned to focus on the face and/or body of the participant. The participant console may include a document camera and a touch panel interface 407. The document camera may focus on documents or visual displays near the user.

The touch panel interface 407 may be configured such that the user can select amongst various inputs and outputs. For example, if the camera 408 of a particular user is active, and the user would prefer that the document camera be active instead, the user may activate the document camera by making a selection from the touch panel interface 407. Other selections can be made from the touch panel interface 407 without deviating from the scope of the present invention. The participant consoles may also include a light source.

All of the components listed above may be electronically coupled to a participant communication interface 405. The participant communication interface 405 allows the participant consoles to communicate with other participant consoles, the slave equipment stations, and any other peripheral components. Various types of communication interfaces may be employed, including, but not limited to, a local area network (LAN), a wireless LAN, a serial port, a parallel port, a IEEE 1394 port, a universal serial bus (USB), or a wire bundle.

In one embodiment of the present invention, a closeable cover 420 is coupled to the housing 401. The closeable cover 420 may closes to protect the video screen 402 and to make the participant console 400 more portable. The video screen 402 may be coupled to the underside of the closeable cover 420, or it may be located within the housing 401 and unassociated with the closeable cover 420. Partitions 422 may also be coupled to the closeable cover 420 and to the housing 401. The partitions 422 may be configured such that they expand when the closeable cover 420 is opened. The partitions 422 may serve many purposes, including an increased sense of privacy. The partitions 422 may also serve as a waveguide to direct sound from the speaker 404 to a user.

In another embodiment of the present invention, the video screen 402 may be located within the housing 401 and unassociated with the closeable cover 420. In this situation, a reflective surface 424 may be coupled to the underside of the closeable cover 420. The video screen 402 may be positioned such that it is viewable by the user as a reflection on the reflective surface 424. Similarly, the camera 408 may be positioned such that the camera 408 can capture an image of the user's reflection in the reflective surface 424.

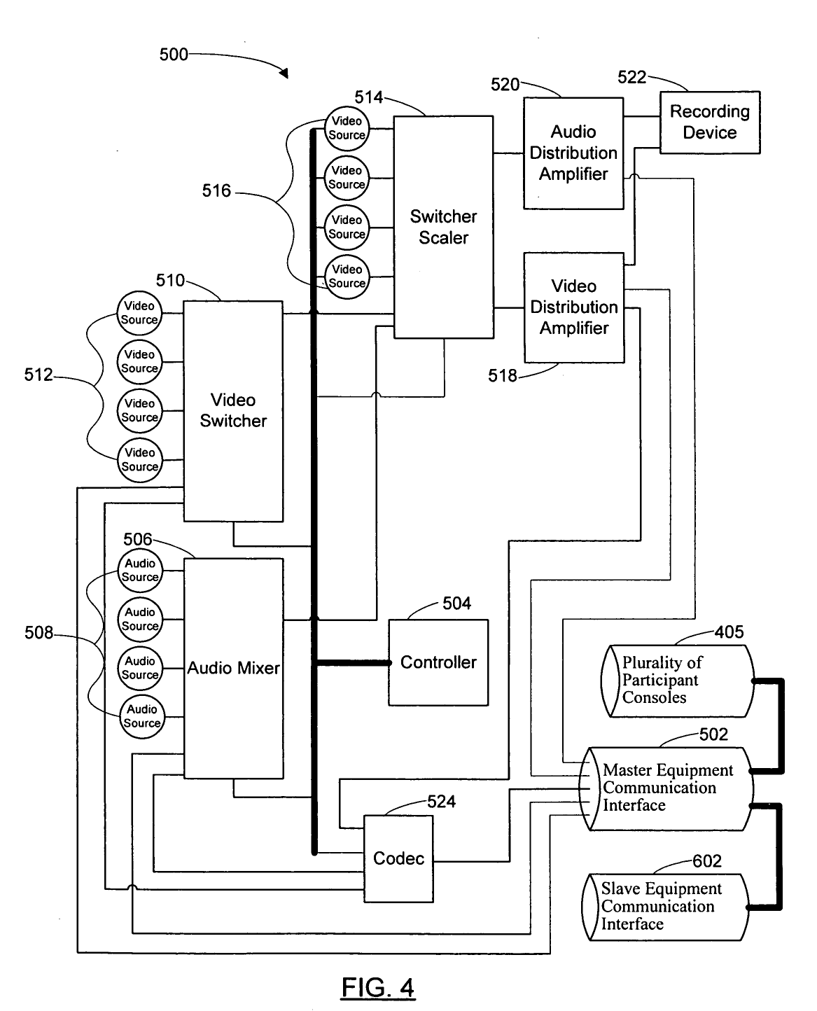

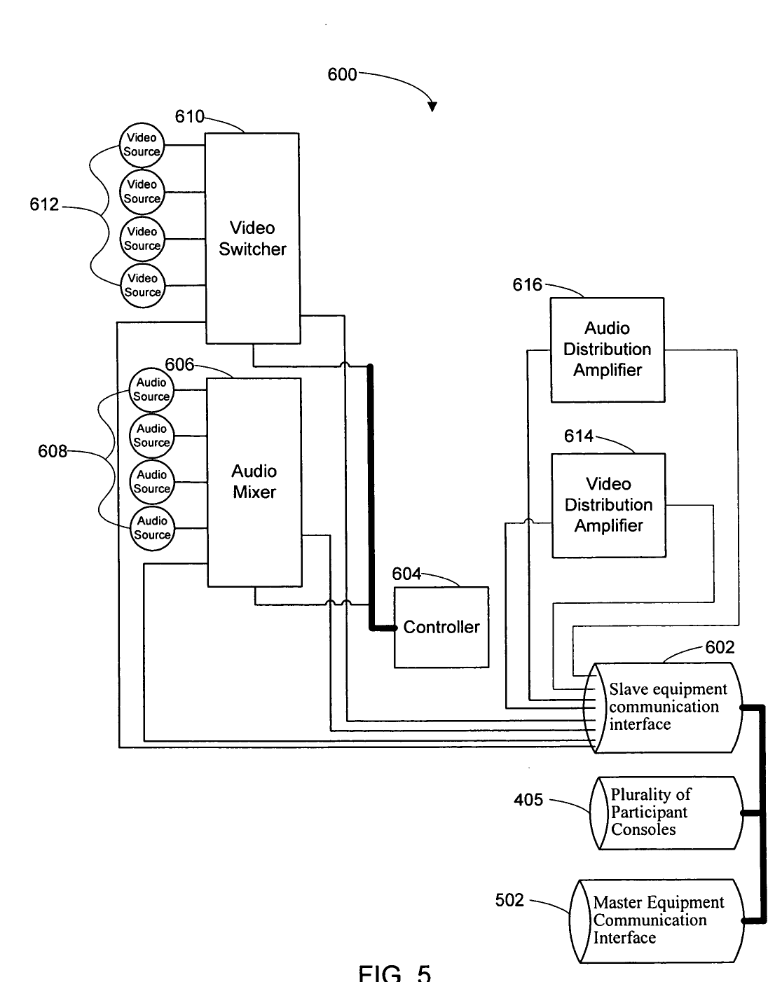

As illustrated in FIGS. 4 and 5, an example embodiment of a master equipment station 500 and a slave equipment station 600 in accordance with the present invention are shown. The master equipment station 500 is configured to receive audio and video signals from multiple participant consoles 400 and from one or more slave equipment stations 600, to process these signals, and to send the resultant output signals to the multiple participant consoles 400 and to the one or more slave equipment stations 600. The master equipment station 500 may be coupled to up to eight participant consoles 400 and to one slave equipment station 600. However, it is also contemplated that the master equipment station 500 may be coupled to any number of participant consoles 400 and slave equipment stations 600.

The master equipment station 500 includes a master controller 504 that supplies logic signals to many of the other devices shown in FIG. 4. The master controller 504 may be electronically coupled to a master audio mixer 506, a master video switcher 510, video input devices 516, and also may be electronically coupled to a codec 524, if included. The master equipment station 500 also includes a master equipment communication interface 502. The master equipment communication interface 502 allows the master equipment station to communicate with the participant consoles 400, the slave equipment stations 600, and other peripheral components. The master equipment communication interface 502 may be electronically coupled to the master audio mixer 506, the master video switcher 510, the master video distribution amplifier 518, the master audio distribution amplifier 520, and the codec 524, if included. Various types of communication interfaces may be employed, including, but not limited to, a local area network (LAN), a wireless LAN, a serial port, a parallel port, a IEEE 1394 port, a universal serial bus (USB), or a wire bundle.

The master audio mixer 506 may be electronically coupled to the master controller 504 and to the master equipment communication interface 502. The master audio mixer 506 is configured to receive audio input signals from a plurality of audio sources 508. In one example embodiment, the audio sources 508 may originate from the participant console microphones 406. However, the audio sources 508 may be any type of audio input. While FIG. 4 only shows four audio sources 508, the master equipment station 500 may be configured to receive any number of audio sources 508. The master audio mixer 506 is configured to select one of the audio sources 508 as an output signal. In one embodiment, the master audio mixer 506 may make this selection automatically by sensing which of the audio sources 508 is active. One possible method of sensing which of the audio sources 508 is active is by sensing which of the audio sources 508 exceeds a predefined voltage threshold.

The master video switcher 510 may be electronically coupled to the master controller 504 and to the master equipment communication interface 502. The master video switcher 510 is configured to receive video input signals from a plurality of video sources 512. In one embodiment, the video sources 512 may originate from the participant console cameras 408 and document cameras 410. While FIG. 4 only shows four video sources 512, the master equipment station 500 may be configured to receive any number of video sources 512. The master video switcher 510 is configured to select one of the video sources 512 as an output signal. In one embodiment, the video source selected as the video output signal by the master video switcher 510 is dependant upon which of the audio sources 508 the master audio mixer 506 has selected as the audio output. This selection results in the camera 408 and the microphone 404 being selected from the same participant console 400. The selection may be done by the master controller 504, which receives data from the master audio mixer 506 describing which of the audio sources 508 has been selected, and then sends a command to the master video switcher 510 to select a corresponding video source 512.

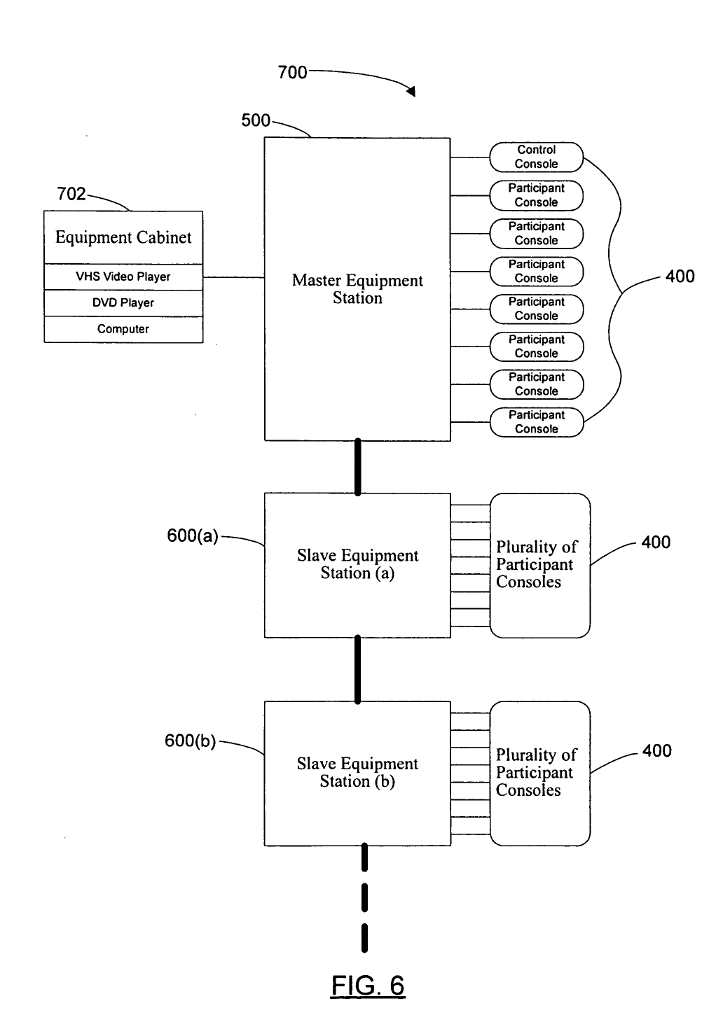

The switcher scaler 514 may be electronically coupled to the master video switcher 510, the master audio mixer 506, the master controller 504, and to at least one video input device 516. The switcher scaler 514 is configured to receive video input signals from a plurality of video sources 516, to receive the audio output produced by the master audio mixer 506, and to receive the video output produced by the master video switcher 510. The video sources 516 may include, but are not limited to, a VHS video player, a DVD player, a document camera, and a computer's graphics card. These video sources may be contained in a separate equipment cabinet illustrated in FIG. 6. The switcher scaler 514 may select one of the video sources 516 or the output from the video switcher 510 as a video output signal and may convert the video source 516 into a video signal output.

The master video distribution amplifier 518 is configured to receive the video signal output from the switcher scaler 514, and to distribute the video signal to various video devices, such as the participant consoles' video screens 402. The master audio distribution amplifier 518 is configured to receive the audio output signal from the switcher scaler 514, and to distribute the audio signal to various audio devices, such the participant consoles' speakers 404.

A recording device 522 may also be provided to keep a record of the audio and video signals that are being produced by the system. In one example embodiment, the recording device 522 only records the signals that are selected by master audio 520 and video 518 distribution amplifiers, which are also the signals sent to the participant consoles 400. In another embodiment, the recording device 522 records all of the signals produced at all times from all of the participant consoles 400. Examples of recording devices may include, but are not limited to, videotape and a hard disk recorder. The recording device 522 may also be electronically coupled to the switcher scaler 516 or both the master audio mixer 508 and the master video switcher 512.

A codec 524 may also be provided in order to format an audio and a video signal preceding an electronic transmission of the audio and the video signal. The codec may be electronically coupled to the master video switcher 512, the master audio mixer 508, the master video distribution amplifier 518, the master controller 504, and to the master equipment communication interface 502.

If it is necessary to provide more participant consoles 400 than the master equipment station 500 is configured to handle, one or more slave equipment stations 600, as shown in FIG. 5, may also be coupled to the system. In one example embodiment, the slave equipment station 600 allows up to eight additional participant consoles 400 to be coupled to the system. The slave equipment station 600 may be similar to the master equipment station 500, but may lack many of the components, such as the switcher scaler 516, the recording device 522, and the codec 524.

The slave equipment station 600 includes a slave controller 604 that supplies logic signals to many of the other devices shown in FIG. 5. The slave controller 604 may be electronically coupled to a slave audio mixer 606, and a slave video switcher 610. The slave equipment station 600 also includes a slave equipment communication interface 602. The slave equipment communication interface 602 allows the slave equipment station 600 to communicate with the participant consoles 400, the master equipment stations 500, other slave equipment stations 600, and other peripheral components. The slave equipment communication interface 602 may be electronically coupled to the slave audio mixer 606, and the slave video switcher 610. The slave equipment communication interface 602 is also electronically coupled to the slave video distribution amplifier 618, and the slave audio distribution amplifier 620 thereby enabling output signals to be sent to the master equipment station 500 for further processing. Various types of communication interfaces may be employed, including, but not limited to, a local area network (LAN), a wireless LAN, a serial port, a parallel port, a FireWire, a universal serial bus (USB), or a wire bundle.

The slave audio mixer 606 may be electronically coupled to the slave controller 604 and to the slave equipment communication interface 602. The slave audio mixer 606 is configured to receive audio input signals from a plurality of audio sources 608. In one example embodiment, the audio sources 608 may originate from the participant console microphones 406. However, the audio sources 608 may be any type of an audio input. While FIG. 5 only shows four audio sources 608, the slave equipment station 600 may be configured to receive any number of audio sources 608. The slave audio mixer 606 is configured to select one of the audio sources 608 as an output signal. In one embodiment, the slave audio mixer 606 may make this selection automatically by sensing which of the audio sources 608 is active. One possible method of sensing which of the audio sources 608 is active is by sensing which of the audio sources 608 exceeds a predefined voltage threshold.

The slave video switcher 610 may be electronically coupled to the slave controller 604 and to the slave equipment communication interface 602. The slave video switcher 610 is configured to receive video input signals from a plurality of video sources 612. In one example embodiment, the video sources 612 may originate from the participant console cameras 408 and document cameras 410. While FIG. 5 only shows four video sources 612, the slave equipment station 600 may be configured to receive any number of video sources 612. The slave video switcher 610 is configured to select one of the video sources 612 at an output signal. In a preferred embodiment, the video source selected as the video output signal by the slave video switcher 610 is dependant upon which of the audio sources the slave audio mixer 606 has selected as the audio output. This selection may result in the camera 408 and the microphone 404 both being selected from the same participant console 400. The selection may be done by the slave controller 604, which receives data from the slave audio mixer 606 describing which of the audio sources 608 has been selected, and then sends a command to the slave video switcher 610 to select a corresponding video source 612.

When the slave audio mixer 606 and slave video switcher 610 select their respective outputs, the slave audio mixer 606 and the slave video switcher 610 send their output signals to a slave equipment communication interface 602. These signals eventually are sent to the master equipment station 500, and may be selected by the master equipment station 500 to be distributed to all of the participant consoles 400 connected to the system.

The slave equipment station 600 also includes a slave audio distribution amplifier 616 and a slave video distribution amplifier 614. The slave distribution amplifiers 616 and 614 are both electronically coupled to the slave equipment communication interface 602. The slave distribution amplifiers 616 and 614 are configured to receive audio and video signals and distribute them to multiple audio and video devices. In one embodiment, the slave audio distribution amplifier 616 and a slave video distribution amplifier 614 receive the audio and video output signals that were selected by the master equipment station 500, and distribute these signals to up to eight participant consoles 400.

As illustrated in FIG. 6, in accordance with an example embodiment of the present invention, multiple slave equipment stations 600(a) and 600(b) can be daisy chained to a single master equipment station 500. The communication between the slave equipment stations 600(a) and 600(b) and the master equipment station 500 may be such that if one user for one of the participant consoles 400 is speaking, that user's voice and image are captured by the microphone and camera, and are displayed on all of the participant consoles 400 coupled to the system.

As illustrated in FIG. 6, an equipment cabinet 702 may also be coupled to the master equipment station 500. The equipment cabinet 702 may include a plurality of video display devices, including, but not limited to, a DVD player, a VHS video player, and a computer.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

What is claimed is:

1. A method for processing interactive communications in a meeting space shared by attending participants who are visually present with each other, comprising the steps of:
a) providing electronic display devices to a plurality of participants, wherein the electronic display devices include individual audio and video monitors;
b) linking the electronic display devices for interactive processing of conference data among at least a portion of the plurality of participants and a speaker; and
c) monitoring and modifying a flow of conference data between the electronic display devices.

2. A method as in claim 1, wherein the step of monitoring and modifying a flow of conference data includes assigning an electronic display device with presenter status.

3. A method as in claim 1, wherein the step of monitoring and modifying a flow of conference data includes assigning communication priority to specific electronic display devices.

4. A method as in claim 1, wherein the step of providing electronic display devices to a plurality of participants includes personalizing display characteristics of the electronic display device to conform to preferences of an individual participant.

5. A method as in claim 1, wherein the step of monitoring and modifying a flow of conference data includes sending viewable media to the electronic display devices.

6. A method as in claim 1, wherein the step of monitoring and modifying a flow of conference data includes tallying voting results from the electronic display devices.

7. A method as in claim 1, further comprising the step of activating a participant's image on another participant's electronic display device, thus enabling interactive communication between at least two participants.

8. A method as in claim 1, further comprising the step of enabling communication between discrete groups of participants within a larger group of participants.

9. A method as in claim 1, wherein conference data includes audio and video originating from participant consoles.

10. A method as in claim 1, wherein conference data includes audio and video originating from an outside video source.

11. A method as in claim 10, wherein the outside source is a DVD player.

12. A method as in claim 10, wherein the outside source is a VCR.

13. A method as in claim 10, wherein the outside source is any computer generated information.

14. A system for processing interactive communications in a meeting space shared by attending participants who are visually present with each other for purposes of enhancing flow of information, comprising:
a) a plurality of participant consoles further comprising;
1) a housing;
2) a participant communication interface coupled to the housing, wherein the participant communication interface facilitates data transmission between the plurality of participant consoles;
3) a video screen electronically coupled to the participant communication interface;
4) a speaker electronically coupled to the participant communication interface;
5) a microphone electronically coupled to the participant communication interface; and
6) a camera electronically coupled to the participant communication interface;
b) a master equipment station configured to be functionally coupled to the plurality of participant consoles, further comprising;
1) a master equipment communication interface configured to be functionally coupled to the participant communication interfaces of the plurality of participant consoles;
2) a master controller configured to supply logic signals to devices within the master equipment station;
3) a master audio mixer electronically coupled to the master controller and to the master equipment communication interface, wherein the master audio mixer is configured to receive at least one audio input signal, wherein the master audio mixer selects one of the audio input signals as an audio output signal;
4) a master video switcher electronically coupled to the master controller and to the master equipment communication interface, wherein the master video switcher is configured to receive at least one video input signal, wherein the master video switcher selects one of the video input signals as a video output signal;
5) a switcher scaler electronically coupled to the master video switcher, the master audio mixer, the master controller, and configured to be electronically coupled to at least one video input device, wherein the switcher scaler is configured to receive at least one video input signal from the at least one video input device, and at least one video input signal from the master video switcher, wherein the switcher scaler converts one of the electronic video input signals into a video signal output;
6) a master video distribution amplifier electronically coupled to the switcher scaler and to the master equipment communication interface, wherein the master video distribution amplifier is configured to receive the video signal output from the switcher scaler and distribute the video signal output to the master communication interface; and
7) a master audio distribution amplifier electronically coupled to the switcher scaler and to the master equipment communication interface, wherein the master audio distribution amplifier is configured to receive an audio signal, wherein the master audio distribution amplifier distributes the audio signal to the master communication interface.

15. The system of claim 14, wherein the system includes at least one slave equipment station configured to be electronically coupled to the plurality of participant consoles and to the master equipment station, further comprising:
a) a slave equipment communication interface;
b) a slave controller configured to supply logic signals to devices within the slave equipment station;
c) a slave audio mixer electronically coupled to the slave controller and the slave equipment communication interface, wherein the slave audio mixer is configured to receive at least one audio input signal, wherein the slave audio mixer selects one of the audio input signals as an audio output signal;
d) a slave video switcher electronically coupled to the slave controller and the slave equipment communication interface wherein the slave video switcher is configured to receive at least one video input signal, wherein the video switcher selects one of the video input signals as a video output signal;
e) a slave video distribution amplifier electronically coupled to the slave equipment communication interface, wherein the slave video distribution amplifier is configured to receive a video signal and distribute the video signal to at least one video display device; and
f) a slave audio distribution amplifier electronically coupled to the slave equipment communication interface, wherein the slave audio distribution amplifier configured to receive an audio signal, wherein the slave audio distribution amplifier distributes the audio signal to at least one audio device.

16. The system of claim 15, wherein at least one of the audio input signals received by the master audio mixer is configured to originate from the audio output signal produced by the slave audio mixer.

17. The system of claim 15, wherein at least one of the video input signals received by the master video switcher is configured to originate from the video output signal produced by the slave video switcher.

18. The system of claim 15, wherein at least one of the video input signals received by the slave video distribution amplifier is configured to originate from the video output signal produced by the master video distribution amplifier.

19. The system of claim 15, wherein at least one of the audio input signals received by the slave audio distribution amplifier is configured to originate from the audio output signal produced by the master audio distribution amplifier.

20. The system of claim 14, wherein the system also includes an equipment cabinet configured to be electronically coupled to the master equipment station, further comprising;
a) an equipment cabinet communication interface; and
b) at least one video display device electronically coupled to the equipment cabinet communication interface;

21. The system of claim 14, wherein one of the plurality of participant consoles is designated as a control console.

22. The system of claim 21, wherein the control consol designation can change dynamically.

23. The system of claim 14, wherein the switcher scaler receives the audio output signal from the master audio mixer and divides it into left and right audio output channel signals.

24. The system of claim 14, wherein the master controller communicates with the peripheral devices by means of an RS232 port.

25. The system of claim 15, wherein the slave controller communicates with the peripheral devices by means of an RS232 port.

26. The system of claim 14, wherein the master equipment station includes a codec electronically coupled to the master video switcher, the master audio mixer, the master video distribution amplifier, the master controller, and to the master equipment communication interface, wherein the codec is configured to format an audio and a video signal preceding an electronic transmission of the audio and the video signal.

27. The system of claim 14, wherein the system also includes a LAN connection electronically coupled to the participant communication interface.

28. The system of claim 14, wherein the system also includes an IEEE 1394 port connection electronically coupled to the participant communication interface.

29. The system of claim 14, wherein the system also includes a wireless interface connection electronically coupled to the participant communication interface.

30. The system of claim 14, wherein the master equipment station includes a recording device, wherein the recording device is configured to store audio and video data.

31. The system of claim 30, wherein the recording device is electronically coupled to the master video distribution amplifier and to the master audio distribution amplifier

32. The system of claim 30, wherein the recording device is electronically coupled to the master switcher scaler.

33. The system of claim 30, wherein the recording device is electronically coupled to the master video switcher and to the master audio mixer.

34. The system of claim 14, wherein the plurality of participant consoles further includes a touch panel interface coupled to the participant communication interface wherein the touch panel interface is configured to receive control commands from a user.

35. The system as in claim 14, further comprising a closeable cover coupled to the housing, wherein the closeable cover opens to expose the video screen.

36. The system as in claim 35, further comprising partitions coupled to the closeable cover and coupled to the housing such that the partitions expand as the closeable cover is opened.

37. The system as in claim 36, wherein the partitions form a waveguide when expanded to direct sound from the speaker to the user.

38. The system as in claim 35, further comprising a reflective surface coupled to the closeable cover, such that the video screen is viewable in the reflective surface by the user.

39. The system as in claim 38, wherein the camera is positioned such that the camera captures an image of a user's reflection in the reflective surface.
